(19) United States
(12) Patent Application Publication
(10) Pub. No.: US 2025/0324944 A1
(43) Pub. Date: Oct. 23, 2025

(54) CAT HAIR AUTOMATIC CLEANING BOX DEVICE

(71) Applicant: Xiaowei HU, Hulunbuir (CN)

(72) Inventor: Xiaowei HU, Hulunbuir (CN)

(21) Appl. No.: 18/735,251

(22) Filed: Jun. 6, 2024

(30) Foreign Application Priority Data
Apr. 22, 2024 (CN) 2024208434031

(51) Int. Cl. A01K 13/00

(52) U.S. Cl. CPC A01K 13/004

(57) ABSTRACT

A cat hair automatic cleaning box device includes a box body and a cat hair combing device. The box body defines a channel for a cat to enter and exit a cat bed, the cat hair combing device is disposed inside the channel, the cat hair combing device includes a first comb and a second comb, and an inner wall of the first comb is provided with inverted spikes to comb cat hair. The first comb and the second comb correspond to each other in sizes and shapes. The cat hair automatic cleaning box device can clean cat hair more conveniently, safely and reliably, improve efficiency of cat hair cleaning, and has a good cleaning effect.

### TECHNICAL FIELD

The disclosure relates to the field of cat hair cleaning technologies, and more particularly to a cat hair automatic cleaning box device.

### BACKGROUND

At present, there are nearly 40 million households that own cats in China, and the cats are the most popular category of pets. With the economy development and fast-paced lifestyle of China, the population of pet owners will gradually expand. However, cat hair cleaning is becoming increasingly a pain point for cat owners, as cat hair is ubiquitous in many cat households, affecting hygiene and health of cat owners.

Current technologies or products that solve the cat hair cleaning are mostly various cat hair combs that require manual operation. After pacifying the cats manually, the various comb products are used to regularly brush off the cat hair on cat body.

Current cat hair cleaning technologies have below disadvantages.
(1) Current cat hair cleaning products require manual participation in a process of removing the cat hair, which can take up time and energy of cat owners. Moreover, the cats lose hair every day in a year due to air conditioning and other reasons, and thus the cat hair need to be constantly cleaned.
(2) A type of pulling tool can cause obvious pain and require the cats to lie on their backs during grooming, which is against their natural instincts, as a result, most of the cats would be afraid and not cooperate with the cat owners during grooming, making a grooming process very cumbersome and even fail.

Each hair follicle on a cat has 7-8 hairs, and each hair is not very firm. The type of pulling tool will also pull off normal cat hair, rather than accurately clean fallen or about to fall cat hair.

Therefore, how to clean the cat hair more conveniently and time-savingly, improve efficiency of cat hair cleaning, and release more time and energy from the pet owners has become a new topic.

### SUMMARY

The disclosure aims at providing a cat hair automatic cleaning box device which can clean cat hair more conveniently, safely and reliably, improve efficiency of cat hair cleaning, and has a good cleaning effect.

To achieve above purposes, the disclosure provides a cat hair automatic cleaning box device including a box body and a cat hair combing device. The box body defines a channel configured for a cat to enter and exit a cat bed, the cat hair combing device is disposed inside the channel, the cat hair combing device includes a first comb, and an inner wall of the first comb is provided with inverted spikes configured to comb cat hair.

In an embodiment, the cat hair combing device further includes a second comb, and the first comb and the second comb correspond to each other in sizes and shapes.

In an embodiment, an area is defined between the first comb and the second comb configured to save fallen cat hair.

In an embodiment, the cat hair automatic cleaning box device further includes a feeding and drinking container disposed in the box body.

In an embodiment, the cat hair automatic cleaning box device further includes a spraying device disposed on the cat hair combing device.

In an embodiment, the spraying device includes a water tank, the water tank is provided with a water level sensor therein, the water tank is provided with a water pump device, the water pump device is provided with a circuit board, and the circuit board is provided with a spraying control circuit.

In an embodiment, a top of the cat hair combing device is provided with a suction pipe outside, a top of the inner wall of the first comb defines a spraying port, and the spraying control circuit is configured to control the spraying port to spray water.

In an embodiment, the spraying control circuit includes a power module, a programmable logic controller (PLC), a motor, the water level sensor, the water pump device, an electromagnetic valve and the spraying device. The power module is configured to supply power to the PLC, the PLC is configured to control the water pump device by the motor, the water level sensor is configured to collect and transmit water level information to the PLC, and the PLC is configured to the control the spraying device by the electromagnetic valve. The power module includes a power supply.

In an embodiment, the PLC is a chip with a model number of ATMEGA32-AU.

In an embodiment, the motor includes a speed sensor configured to stabilize voltage and measure speed of the motor.

The technical solutions of the disclosure have following beneficial effects: (1) The cat hair combing device is disposed inside the channel, the cat hair combing device includes at least one comb, an inner wall of each of the at least one comb is provided with the inverted spikes configured to comb the cat hair. The disclosure cleans the cat hair by the inverted spikes when the cat passes through the channel, the cat hair is cleaned more conveniently, safely and reliably with a great cleaning effect. (2) The cat hair combing device is provided with the spraying device, when the cat passes through the channel, the disclosure can not only clean the cat hair but also perform automatic cleaning to the cat. The disclosure has diverse functions and more flexible and simple operations. (3) The disclosure improves the efficiency of the cat hair cleaning, greatly releases energy and time of cat owners, and is suitable for widespread promotion.

### BRIEF DESCRIPTION OF DRAWINGS

To describe more clearly the technical solutions in the embodiments of the disclosure or in the related art, accompanying drawings in the embodiments of the disclosure or in the related art are simply introduced below. Apparently, the accompanying drawings described below are only some embodiments of the disclosure, those skilled in the art can obtain other drawings according to structures illustrated by the accompanying drawings without creative labor.

FIG. 1 illustrates a schematic structural diagram of a cat hair automatic cleaning box device according to an embodiment of the disclosure.

FIG. 2 illustrates a schematic exploded view of the cat hair automatic cleaning box device according to the embodiment of the disclosure.

FIG. 3 illustrates another schematic exploded view of the cat hair automatic cleaning box device according to the embodiment of the disclosure.

FIG. 4 illustrates a schematic structural diagram of a cat hair combing device of the cat hair automatic cleaning box device of the disclosure.

FIG. 5 illustrates another schematic structural diagram of the cat hair combing device of the cat hair automatic cleaning box device of the disclosure.

FIG. 6 illustrates a schematic structural diagram of a first comb of the cat hair automatic cleaning box device of the disclosure.

FIG. 7 illustrates a schematic block diagram of a spraying control circuit of the cat hair automatic cleaning box device of the disclosure.

The purpose, functional features, and advantages of the disclosure are further explained in conjunction with the embodiments, with reference to the accompanying drawings.

### DETAILED DESCRIPTION OF EMBODIMENTS

The technical solutions in the embodiments of the disclosure are described completely and clearly below in conjunction with the accompanying drawings. It is apparent that the embodiments described are just a part of embodiments of the disclosure, not all of them. Based on the embodiments of the disclosure, other embodiments obtained by those skilled in the art without creative labor fall within the scope of protection of the disclosure.

It should be noted that all directional indications (such as up, down, left, right, front, and back etc.) in the embodiments of the disclosure are only used to explain a relative position relationship and motion situation between components in a specific posture (as shown in the accompanying drawings). If the specific posture changes, the directional indications also change accordingly.

In the disclosure, unless otherwise explicitly defined and limited, terms “connect” and “fix” etc., should be broadly understood, for example, “fix” can be a fixed connection, a detachable connection, or be integrated into one whole; or it can be a mechanical connection or an electrical connection; or it can be a direct connection or an indirect connection through an intermediate medium; or it can be an internal connection of two components or an interaction relationship between two components, unless otherwise specified. For those skilled in the art, specific meanings of the above terms in the disclosure can be understood based on specific circumstances.

In addition, in the disclosure, descriptions related to “first” and “second” etc., are only used for descriptive purposes and cannot be understood as indicating or implying their relative importance or implying the number of indicated technical features. Therefore, the features limited to “first” and “second” can explicitly or implicitly include at least one of the features. In addition, the technical solutions between various embodiments can be combined with each other, but must be based on what those skilled in the art can achieve. When a combination of technical solutions is contradictory or impossible to achieve, it should be considered that the combination of such technical solutions does not exist and is not within the scope of protection required by the disclosure.

The disclosure provides a cat hair automatic cleaning box device.

### Embodiment 1

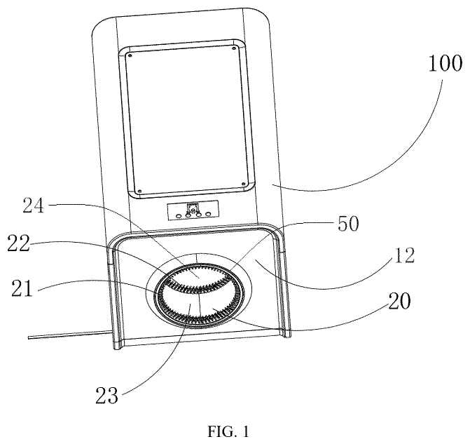

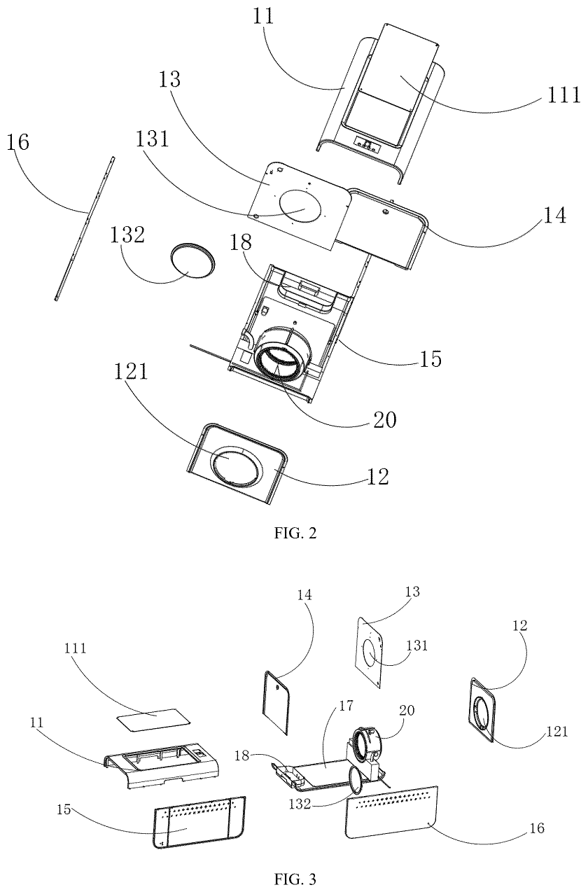

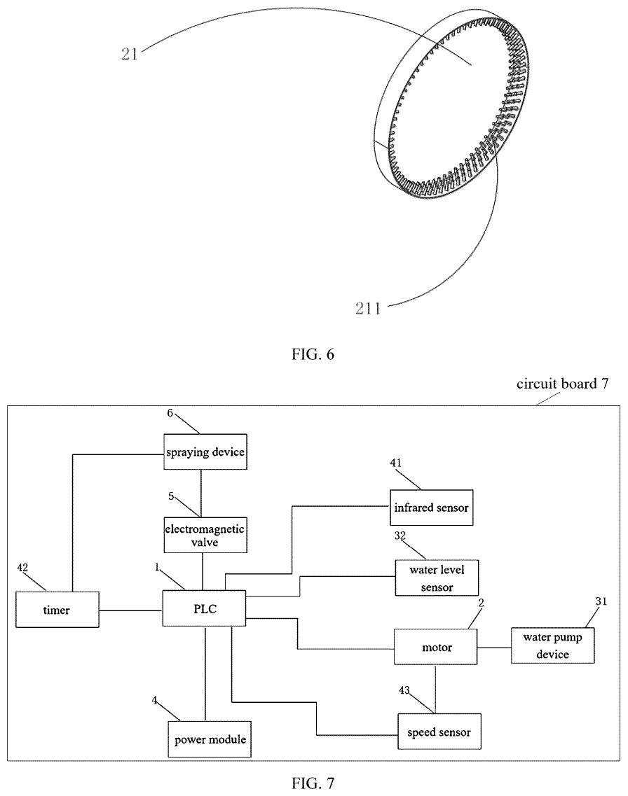

Referring to FIG. 1 to FIG. 6, the cat hair automatic cleaning box device includes: a box body 100, preferably, the box body 100 includes a top cover 11, an upper cover 111, a front cover 12, a right side plate 15, a left side plate 16, a rear cover 14, a bottom plate 17 and a channel-defining part 20. Furthermore, the top cover 11 and the bottom plate 17 are connected to two ends of the left side plate 16 respectively, the right side plate 15 is disposed corresponding to the left side plate 16 and two ends of the right side plate 15 are connected to the top cover 11 and the bottom plate 17 respectively, the front cover 12 is connected to the top cover 11, the right side plate 15, the left side plate 16 and the bottom plate 17, the rear cover 14 is disposed corresponding to the front cover 12 and is connected to the top cover 11, the right side plate 15, the left side plate 16 and the bottom plate 17, and the upper cover 111 is detachably connected to the top cover 11. When cleaning the box body 100, the upper cover 111 can be opened for convenience. The front cover 12 defines a hole 121 corresponding to the channel-defining part 20, the channel-defining part 20 is connected to the front cover 12, and the channel-defining part 20 defines a channel 24 connected to the hole 121.

The box body 100 can used as a cat bed and a cat can enter the cat bed to rest.

In the embodiment, a feeding and drinking container 18 is disposed in the box body 100, and the feeding and drinking container 18 is configured to place cat food and drinking water. Furthermore, the feeding and drinking container 18 may be arranged at a rear end of the box body 100.

The channel 24 is configured for the cat to enter and exit the cat bed. Preferably, a cat hair combing device 50 is disposed inside the channel 24, the cat hair combing device 50 includes a first comb 21, and an inner wall of the first comb 21 is provided with inverted spikes 211 configured to comb cat hair.

Preferably, a blocking plate 13 is disposed in a direction towards the bottom plate 17 behind the channel 24, the blocking plate 13 defines a blocking hole 131, the blocking hole 131 correspond to the channel 24 in positions and sizes, and the blocking hole 131 is configured to protect the channel 24. When the cat hair automatic cleaning box device is in use, the cat can entry and exit the channel 24 by the blocking hole 131. Furthermore, preferably, a cover 132 is disposed in a direction towards the bottom plate 17 behind the channel 24, when the cat hair automatic cleaning box device is not in use, the cover 132 can block the channel 24 to prevent dust entering. Furthermore, preferably, the cover 132 correspond to the blocking hole 131 in positions and sizes.

In the embodiment, the cat hair combing device 50 is cylindrical, the cat hair combing device 50 is arranged on the front cover 12 of the box body 100. The first comb 21 is in a ring shape, the inner wall of the first comb 21 is provided with the inverted spikes 211 configured to comb cat hair, the first comb 21 in the ring shape is embedded on an inner wall of the cat hair combing device 50, and a size and the shape of the first comb 21 correspond to a size and a shape of the inner wall of the cat hair combing device 50.

In the embodiment, the cat hair combing device 50 further includes a second comb 22, and the first comb 21 and the second comb 22 correspond to each other in sizes and shapes.

In the embodiment, the size, the shape and a structure of the first comb 21 are same as the size, shape and structure of the second comb 22. The second comb 22 is also in a ring shape and an inner wall of the second comb 22 is also provided with inverted spikes.

In the embodiment, preferably, the inverted spikes 211 on the first comb 21 are developed based on bionic components, and a shape, size, hardness, and other aspects of the inverted spikes 211 mimic cat tongues and protruding protrusions on the cat tongues, and are manufactured by using customized materials.

When the cat passes through the cat hair combing device 50, the cat hair that is fallen or about to fallen on the cat can be scraped off by frictional physical effects such as compression, combing, scraping, and adhesion etc., achieving a purpose of cleaning the cat hair.

In the embodiment, preferably, the area 23 is defined between the first comb 21 and the second comb 22 and configured to save fallen cat hair.

The area 23 configured to save fallen cat hair is a hair storage area with certain elasticity and adsorption capacity. When the cat passes through the area 23, cat hair that has already fallen off outside cat fur can be absorbed through physical effects such as the compression, friction, and static electricity etc., preventing the cat hair from scattering randomly. When there is much cat hair in the area 23, the area 23 can be easily cleaned or replaced.

An operating principle and process of the disclosure are below.
1. A cat eats and rests multiple times in a single day, and locates cat food according to its sense of smell and habits. When the cat finds that it needs to pass through the channel 24 to eat or rest, the cat will not be afraid or refuse due to a habit of searching for food in a closed environment.
2. When trying to enter the channel 24, the cat firstly touches the cat hair combing device 50, when passing through the cat hair combing device 50, the cat feels like licking hair with its own tongue, and then enters the area 23, because the structures, shapes and hardness of the first comb 21 and the second comb 22 are similar to those of a cat tongue.
3. An entrance of the area 23 can be set slightly smaller, but soft and elastic. When the cat enters the area 23, a certain amount of the friction and the static electricity will be generated, which has a certain adsorption effect and can absorb floating hair on the cat.
4. When the cat finishes eating or resting and exits the box body 100, it will repeat above steps.

### Embodiment 2

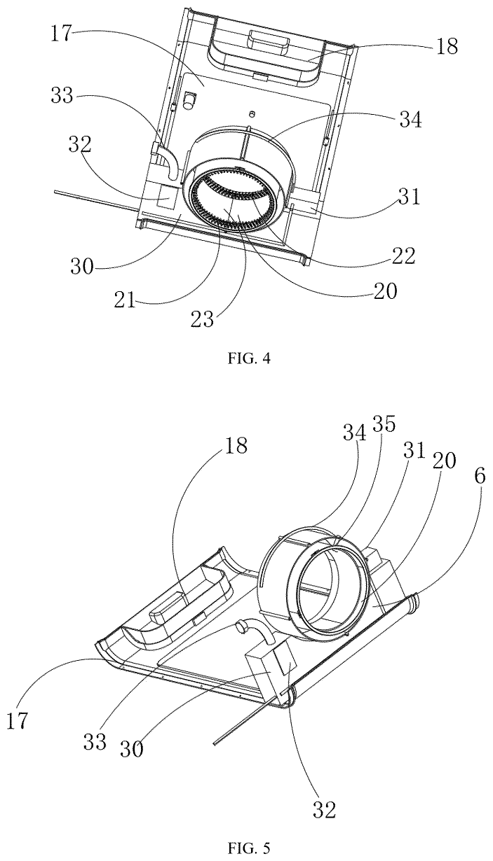

Referring to FIG. 4 and FIG. 5, in the embodiment, preferably, the cat hair combing device 50 is provided with a spraying device 6 thereon.

In the embodiment, preferably, the spraying device 6 includes a water tank 30, the water tank 30 is provided with a water level sensor 32 inside, the water tank 30 is provided with a water pump device 31, and the water pump device 31 is provided with a circuit board 7, and the circuit board 7 is provided with a spraying control circuit.

Furthermore, preferably, the water tank 30 is disposed below the cat hair combing device 50, a side of the cat hair combing device 50 is provided with the water pump device 31, another side of the cat hair combing device 50 is provided with a water injection pipe 33, the water injection pipe 33 is disposed on the water tank 30, and the water injection pipe 33 is configured to inject water into the water tank 30.

In the embodiment, preferably, a top of an outside of the cat hair combing device 50 is provided with a suction pipe 34, furthermore, the suction pipe 34 is bent along the top of the outside of the cat hair combing device 50. A top of the inner wall of the first comb 21 defines a spraying port 35. Of course, according to actual needs, the top of the inner wall of the first comb 21 can define another spraying port (not shown in the accompanying drawings). The spraying control circuit is configured to control the spraying port 35 to spray water.

The water injection pipe 33 is installed at a side of the box body 100 and connected to the water tank 30 inside the box body 100, a diameter of the water injection pipe 33 is about 2 centimeters (cm), and the water injection pipe 33 is a rubber hose.

The water tank 30 has a volume of about 1.5 liters (L) and is made of acrylonitrile butadiene styrene (ABS) material.

The suction pipe 34 is connected to the water tank 30, and an atomizing nozzle is disposed in the spraying port 35. The atomizing nozzle is used for water flow, and is made of rubber with a diameter of approximately 0.3 cm.

The water pump device 31 is a micro water pump, with a rated voltage of 5 volts (V), a rated current of 600 milliamperes (mA), a power of 3 watts (W), a maximum water pressure of 30 pounds per square inch (psi) (i.e., 200 kilopascal), a noise level less than 65 decibel (dB), a head greater than 5 meters (m), a suction head greater than 5 m, and a water spray rate in a range of 0.3-1.2 liters per minute (L/min).

The spraying port 35 includes the atomizing nozzle, the atomizing nozzle is made of 304 stainless steels with a thread structure for convenient fixation, and the atomizing nozzle has a spray hole diameter of 0.66 millimeters (mm) and a water pressure of 4 kilograms per centimeter (kg/cm). when a spray distance of the atomizing nozzle is 10 cm, a spray angle of the atomizing nozzle can reach about 110 degrees, and a flow rate of the atomizing nozzle can reach 0.51 L/min.

The spraying device 6 is configured to control the atomizing nozzle to spray clean atomized water to simulate saliva on the cat tongue and the protrusions, comb the cat hair, and adsorb floating hair from the cat.

### Embodiment 3

Referring to FIG. 7, in the embodiment, preferably, the spraying control circuit includes a power module 4, a programmable logic controller (PLC) 1, a motor 2, the water level sensor 32, the water pump device 31, an electromagnetic valve 5 and the spraying device 6. The power module 4 is configured to supply power to the PLC 1, the PLC 1 is configured to control the water pump device 31 by the motor 2, the water level sensor 32 is configured to collect and transmit water level information to the PLC 1, the PLC 1 is configured to control the water level sensor 32, and the PLC 1 is configured to control the spraying device 6 by the electromagnetic valve 5.

In the embodiment, preferably, the PLC 1 is a chip with a model number of ATMEGA32-AU.

In the embodiment, preferably, the PLC 1 includes an infrared sensor 41, the infrared sensor 41 is configured to sense and detect location information, i.e., a distance between the cat and the cat hair combing device 50, and to transmit the location information to the PLC 1, and the PLC 1 is configured to control the spraying device 6 to spray water.

In other words, when the infrared sensor 41 detects that the cat is very close to the cat hair combing device 50, the PLC 1 controls the spraying device 6 to stop spraying water. When the cat is far from the cat hair combing device 50, the PLC 1 controls the spraying device 6 to spray water to simulate the saliva on the cat tongue and the protrusions, then when the cat enters the cat hair combing device 50, the cat hair is combed, and the floating hair from the cat is adsorbed.

In the embodiment, the PLC 1 includes a timer 42, the timer 42 is configured to control the spraying device 6 to spray water at a regular time.

In the embodiment, the PLC 1 is configured to control the spraying device 6 by the timer 42 to spray water continuously for about 5 seconds with a spraying water amount of 0.042 L on surfaces of the combs and the area 23 of the cat hair combing device 50, to simulate a wetting effect of the saliva attached to the cat tongue and the protrusions.

In the embodiment, furthermore, the motor 2 includes a speed sensor 43 configured to stabilize voltage and measure speed of the motor 2 to keep the motor 2 operating stably. An operating principle and a process of this embodiment are below.
1. The cat eats and rests multiple times in a single day, and locates cat food according to its sense of smell and habits. When the cat finds that it needs to pass through the channel 24 to eat or rest, the cat will not be afraid or refuse due to a habit of searching for food in a closed environment.
2. The spraying device 6 sprays the clean atomized water at a regular time to simulate the saliva on the cat tongue and the protrusions.
3. When trying to enter the channel 24, the cat firstly touches the combs, when passing through the combs, the cat feels like licking hair with its own tongue, and then enters the area 23, because the structures, shapes and hardness of the combs are similar to those of a cat tongue.
4. An entrance of the area 23 is slightly smaller, but soft, wet and elastic. When the cat enters the area 23, a certain amount of friction, liquid adhesion and static electricity are generated, which achieves a certain adsorption effect like the cat tongue and can absorb floating hair on the cat.
5. When the cat finishes eating or resting and exits the box body 100, it will repeat above steps.

When cleaning cat hair by the disclosure, manual participation is upgraded to automatic completion, reducing the burden on pet owners, ensuring a 24-hour operation a day, and in a timely and effective manner, reducing the burden and potential harm caused by the cat hair to the pet owners.

The embodiments described above are only preferred embodiments of the disclosure, and not intended to limit the patent scope of the disclosure. Without departing from the spirit and scope of the disclosure, the disclosure may undergo various changes and improvements. Any equivalent structural changes made using the description and accompanying drawings of the disclosure, or directly/indirectly applied in other related technical fields, are included in the patent protection scope of the disclosure.

What is claimed is:

1. A cat hair automatic cleaning box device, comprising:
a box body, wherein the box body defines a channel configured for a cat to enter and exit a cat bed; and
a cat hair combing device, disposed inside the channel, wherein the cat hair combing device comprises: a first comb, and an inner wall of the first comb is provided with inverted spikes configured to comb cat hair.

2. The cat hair automatic cleaning box device as claimed in claim 1, wherein the cat hair combing device further comprises: a second comb, and the first comb and the second comb correspond to each other in sizes and shapes.

3. The cat hair automatic cleaning box device as claimed in claim 2, wherein an area is defined between the first comb and the second comb, and configured to save fallen cat hair.

4. The cat hair automatic cleaning box device as claimed in claim 3, further comprising: a feeding and drinking container disposed in the box body.

5. The cat hair automatic cleaning box device as claimed in claim 4, further comprising: a spraying device disposed on the cat hair combing device.

6. The cat hair automatic cleaning box device as claimed in claim 5, wherein the spraying device comprises a water tank, the water tank is provided with a water level sensor therein, the water tank is provided with a water pump device, the water pump device is provided with a circuit board, and the circuit board is provided with a spraying control circuit.

7. The cat hair automatic cleaning box device as claimed in claim 6, wherein a top of the cat hair combing device is provided with a suction pipe outside, a top of the inner wall of the first comb defines a spraying port, and the spraying control circuit is configured to control the spraying port to spray water.

8. The cat hair automatic cleaning box device as claimed in claim 7, wherein the spraying control circuit comprises: a power module, a programmable logic controller (PLC), a motor, the water level sensor, the water pump device, an electromagnetic valve and the spraying device; wherein the power module is configured to supply power to the PLC, the PLC is configured to control the water pump device by the motor, the water level sensor is configured to collect and transmit water level information to the PLC, and the PLC is configured to control the spraying device by the electromagnetic valve.

9. The cat hair automatic cleaning box device as claimed in claim 8, wherein the PLC is a chip with a model number of ATMEGA32-AU.

10. The cat hair automatic cleaning box device as claimed in claim 9, wherein the motor comprises a speed sensor configured to stabilize voltage and measure speed of the motor.

11. A cat hair automatic cleaning box device, comprising:
a box body, comprising: a top cover, a front cover, a right side plate, a left side plate, a rear cover, a bottom plate, a channel-defining part, and an upper cover; wherein the top cover and the bottom plate are connected to two ends of the left side plate respectively, the right side plate is disposed corresponding to the left side plate and two ends of the right side plate are connected to the top cover and the bottom plate respectively, the front cover is connected to the top cover, the right side plate, the left side plate and the bottom plate, the rear cover is disposed corresponding to the front cover and is connected to the top cover, the right side plate, the left side plate and the bottom plate, the upper cover is detachably connected to the top cover, the front cover defines a hole corresponding to the channel-defining part, the channel-defining part is connected to the front cover, and the channel-defining part defines a channel connected to the hole;
a cat hair combing device disposed inside the channel, comprising: a first comb and a second comb; wherein the first comb and the second comb are disposed in the channel and connected to an inner wall of the channel-defining part, an area is defined between the first comb and the second comb configured to save fallen cat hair, an inner wall of each of the first comb and the second comb is provided with inverted spikes; and
a spraying device, comprising: a water tank, a water pump device, a water injection pipe and a suction pipe; wherein the water tank is disposed below the cat hair combing device, the water pump device is disposed on the water tank at a side of the cat hair combing device, the water injection pipe is disposed on the water tank at another side of the cat hair combing device, the suction pipe is disposed along a top of an outside of the cat hair combing device, and the water pump device is provided with a circuit board provided with a spraying control circuit.

12. The cat hair automatic cleaning box device as claimed in claim 11, wherein a top of the inner wall of the first comb defines a spraying port, and the spraying control circuit is configured to control the spraying port to spray water.

13. The cat hair automatic cleaning box device as claimed in claim 12, wherein the spraying control circuit comprises a power module, a programmable logic controller (PLC), a motor, a water level sensor, the water pump device, an electromagnetic valve and the spraying device; wherein the power module is configured to supply power to the PLC, the PLC is configured to control the water pump device by the motor, the water level sensor is configured to collect and transmit water level information to the PLC, and the PLC is configured to the control the spraying device by the electromagnetic valve.

14. The cat hair automatic cleaning box device as claimed in claim 13, wherein the PLC comprises an infrared sensor configured to sense and detect location information.
